(19) United States
(12) Patent Application Publication
(10) Pub. No.: US 2016/0093187 A1
(43) Pub. Date: Mar. 31, 2016

(54) Sound and Temperature Sensors for Environmental Anomaly Detection

(71) Applicant: MivaLife Mobile Technology, Inc., George Town, KY (US)

(72) Inventors: Junmin Zhang, Zhuhai (CN); Xiang Yan, Zhuhai (CN); Yanyuan Huang, Zhuhai (CN); Hongjuan Zhao, Zhuhai (CN); Guohua Zhang, Zhuhai (CN); Zhanmin Wu, Zhuhai (CN); Qin Yuan, Zhuhai (CN)

(21) Appl. No.: 14/866,205

(22) Filed: Sep. 25, 2015

(30) Foreign Application Priority Data
Sep. 26, 2014 (CN) 201410504928.3

(51) Int. Cl. G08B 17/06; G08B 25/10; G08B 17/117; G01K 13/02; H04R 29/00

(52) U.S. Cl. CPC G08B 17/06; G01K 13/02; H04R 29/00; G08B 17/117; G08B 25/10; G01K 2013/024

(57) ABSTRACT

The sound wave and temperature sensor of the present disclosure can be used for detecting whether a fire accident occurs within a specific area without risking altering or damaging existing sensors, and can be a part of an intelligent home security system. One aspect is to provide an integrated sound wave and temperature sensor that can efficiently work together with the existing sensors. An example apparatus can include a sound sensor, a temperature sensor, a communication circuit, and a microcontroller. The microcontroller can be configured to, responsive to the sound sensor detecting an audible alarm emitted from an environmental detector, determine whether an ambient temperature exceeds a threshold value. Further, the microcontroller can, responsive to both the sound sensor detecting the audible alarm and the ambient temperature exceeding a threshold value, cause the communication circuit to transmit an alert to a recipient.

### PRIORITY CLAIM

This application claims priority to China Patent Application No. 201410504928.3, filed on Sep. 26, 2014, which is incorporated by reference herein in its entirety.

### TECHNICAL FIELD

The present disclosure relates to the sensor field, in particular, to a sound wave and temperature sensor and a detecting method of the sound wave and temperature sensor.

### BACKGROUND

Nowadays, in many families and public places, sensors for fire detection are installed. These sensors typically include a smoke sensor, a carbon monoxide (CO) sensor, and so on. These sensors can send sound and light alarm signals, for example through a buzzer, an indicator light, or the like. Some of them can also transmit alarm signals through a wired network to a backend server, and send the alarm signals through the server when detecting an overly high smoke concentration or CO concentration in the air.

However, since a mistake can be made in judging whether a fire accident occurs only through the signals detected by the smoke sensor and the CO sensor, it is generally preferable to combine the smoke sensor or the CO sensor with a temperature sensor, and then to judge whether a fire accident occurs by comprehensively taking the signals of the smoke sensor, the CO sensor, and the temperature sensor into consideration. In this way, several independent sensors need to be installed in a monitoring area, and the several sensors send signals separately; this often results in a large amount of data processing of the backend server and an overly high cost.

One approach is to attach a temperature sensor to the existing smoke sensor and CO sensor for detecting vibrations of the smoke sensor and the CO sensor when they signal the alarm. The temperature sensor attached can help judge whether a fire accident occurs through the vibrations in combination with the temperature signals collected by the temperature sensor itself, and send the alarms when judging that a fire accident has occurred.

However, such temperature sensor, which needs to cling to the sensors such as the smoke sensor and the CO sensor to detect the vibrations, may affect the detection accuracy of the smoke sensor and the CO sensor, and may also cause legal disputes. In particular, because the smoke sensor and the CO sensor are usually installed and used by a third party, the temperature sensor clinging to the smoke sensor and the CO sensor may affect the work of the smoke sensor and the CO sensor, resulting in a difficulty in determining which sensors fail when an accident occurs, thereby generating unnecessary legal disputes. Moreover, the process of the temperature sensor clinging to the smoke sensor and the CO sensor may also damage the structures of the smoke sensor and the CO sensor, leading to failures of those sensors.

Furthermore, most of the existing temperature sensors are connected to a backend server via wired communications, and use an alternating current (AC) power supply, so that the installation and application thereof are often subject to greater restrictions, thus cumbersome to use for many people.

### BRIEF DESCRIPTION OF THE DRAWINGS

FIG. 1 is a structural diagram of an example of a sound wave and temperature sensor according to the present disclosure.

FIG. 2 is a flow chart of an example of a working method of a sound wave and temperature sensor according to the present disclosure.

FIG. 3 is a schematic diagram of an example connection scheme of a sound wave and temperature sensor communicating with other devices.

With reference to the accompanying drawings and examples below, the present disclosure is further explained.

### DETAILED DESCRIPTION

The sound wave and temperature sensor of the present disclosure can used for detecting whether a fire accident occurs within a specific area and for realizing remote monitoring based on Internet of things, thereby constituting a part of an intelligent home security system.

As introduced here, one aspect of the present disclosure is to provide an integrated sound wave and temperature sensor that can efficiently work together with the existing sensors.

Another aspect of the present disclosure is to provide a method of applying a sound wave and temperature sensor introduced here for remote monitoring.

In order to achieve the first aspect, a sound wave and temperature sensor introduced here can include a sound wave sensor and a sound wave processing circuit used for processing sound wave signals collected by the sound wave sensor. The sound wave and temperature sensor can be further provided with a temperature sensor and a temperature processing circuit used for processing temperature signals collected by the temperature sensor. The sound wave and temperature sensor can be further provided with a microcontroller operable for receiving the signal outputs by the sound wave processing circuit and the temperature processing circuit. After receiving the signal outputs by the sound wave processing circuit, the microcontroller can send out an alarm when the microcontroller determines that the received signals are audio alarm signals emitted by an existing sensor (e.g., a smoke sensor, or a CO sensor), and/or that the temperature represented by the readings from the temperature processing circuit is higher than a threshold value (or, additionally or alternatively, is rising faster than a threshold In some embodiments, the sound wave and temperature sensor is further provided with a wireless signal transceiving circuit electrically connected with the microcontroller. The wireless signal transceiving circuit can be used for sending the alarm raised by the microcontroller.

In this way, the sound wave and temperature sensor (e.g., together with the microcontroller) introduced here can raise an alarm by detecting the audio alarm signals sent by the existing sensors (such as a smoke sensor or a CO sensor) while judging whether the temperature detected by the temperature sensor is higher than the threshold value (or is rising faster than the threshold rate), and if so, the microcontroller sends the alarm (e.g., through the wireless signal transceiving circuit) to a designated location (e.g., a remote computer server and/or a home owner). This is useful for implementing long-distance remote monitoring. In addition, because the sound wave and temperature sensor detects the alarm signals emitted by the existing sensor by measuring a sound wave, it need not cling to the existing sensors that emit audio alarm, thereby avoiding altering, damaging, or otherwise adversely affecting the existing sensors (e.g., the smoke sensor and the CO sensor).

In one preferred embodiment, the sound wave and temperature sensor is further provided with a storage battery supplying power to the microcontroller, thereby obviating the need for an AC power source. In this embodiment, because the sound wave and temperature sensor is powered by the storage battery and does not use AC power, there is less restriction on the installation and application environment thereof. This can avoid any potential, adverse environmental impact on the sound wave and temperature sensor's functions. For example, a battery-powered sound wave and temperature sensor can still function during the outage of the AC power, which can happen during a fire accident.

To achieve the second aspect, the working method of a sound wave and temperature sensor provided by the present disclosure includes: after receiving the signals output by a sound wave processing circuit and a temperature processing circuit, a microcontroller sends alarm signals through the wireless signal transceiving circuit when judging that the signals output by the sound wave processing circuit are alarm signals sent by an audio sensor and the temperature represented by the received signals output by the temperature processing circuit is higher than a threshold value.

In particular, the sound wave and temperature sensor introduced here can first detect whether there are alarm signals sent by an audio emitting sensor such as a smoke sensor and a CO sensor. Then, the sound wave and temperature sensor can judge whether the temperature detected by the temperature sensor is overly high (or is increasing overly fast). Based on these readings collected by the sound wave sensor and the temperature sensor, the sound wave and temperature sensor enables (e.g., via a microcontroller) to judge whether a fire accident has occurred. Therefore, the sound wave and temperature sensor introduced here need not cling to any existing, audio-emitting sensors, thereby avoiding the impact on the functioning of the existing sensors.

Moreover, the sound wave and temperature sensor that can send the alarm signals through the wireless signal transceiving circuit is suitable for remote monitoring, thereby enabling the implementation of a home intelligent security system.

In one embodiment, when judging that the signals output by the sound wave processing circuit are not the alarm signals sent by existing, audio-emitting sensors (e.g., by the sound wave processing circuit only detecting a certain unique frequency range), the microcontroller enters a sleep mode. In this embodiment, the microcontroller need not stay in a working state all the time, but can be awakened to work after receiving an alarm emitted by the existing sensors, thereby reducing the power consumption.

In a further embodiment, when judging that the temperature represented by the readings of the temperature processing circuit is lower than a threshold value, the microcontroller enters a sleep mode.

Based on the above, when judging that the fire accident occurrence condition is not met, the microcontroller enters a sleep mode, thereby saving the power consumption. This can increase the battery lifetime of the sound wave and temperature sensor.

In a further embodiment, after sending the alarm signal through the wireless signal transceiving circuit, the microcontroller enters a sleep mode. After sending the alarm signals, the microcontroller can resume to be in a sleep mode, thereby saving the power consumption thereof.

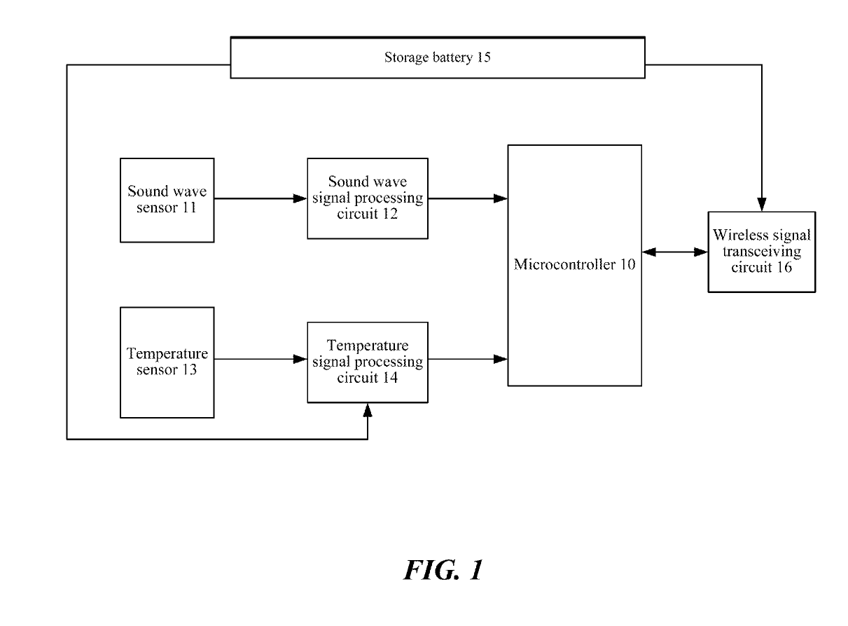

With reference to FIG. 1, an embodiment of the sound wave and temperature sensor of the present disclosure includes a microcontroller 10, a sound wave sensor 11, a sound wave signal processing circuit 12, a temperature sensor 13, a temperature signal processing circuit 14, a storage battery 15, and a wireless signal transceiving circuit 16. The storage battery 15 supplies power to the microcontroller 10, the wireless signal transceiving circuit 16, etc.

The microcontroller 10 is a core part of the sound wave and temperature sensor. The microcontroller 10 controls the work of the sound wave and temperature sensor. The sound wave sensor 11 is used for collecting sound wave signals sent by the existing, audio-emitting sensor. For example, the sound wave sensor 11 can collect the sound emitted by the audio-emitting sensor capable of giving an audio alarm, such as a smoke sensor and a CO sensor. In some implementations, the sound wave sensor 11 may be a microphone, or the like. The sound wave signal processing circuit 12 can be used for processing the signals collected by the sound wave sensor 11, such as filtering, amplification, comparison, and so on, while converting analog signals into digital signals. Some embodiments of the sound wave signal processing circuit 12 can output the analog signals and/or the digital signals to the microcontroller 10 at or around the same time.

The temperature sensor 13 is used for detecting an ambient temperature around the sound wave and temperature sensor, and for outputting the detected temperature signals to the temperature signal processing circuit 14. The temperature signal processing circuit 14 processes the temperature signals detected by the temperature sensor, such as filtering, amplification, comparison, and so on, while converting analog signals into digital signals. Some embodiments of the temperature signal processing circuit 14 can output the analog signals and the digital signals to the microcontroller 10 at or around the same time.

After receiving the signals from the sound wave signal processing circuit 12 and the temperature signal processing circuit 14, the microcontroller 10 examines the signals from the sound wave signal processing circuit 12 and judges whether the signals from the sound wave signal processing circuit 12 are the alarm signals sent by the existing, audio-emitting sensors. In some embodiments, an audio comparator can be built in the microcontroller 10, and the alarm audio signals which may sent by certain specific audio-emitting sensors are pre-stored as sample signals for comparison. For example, after receiving the signals from the sound wave signal processing circuit 12, the microcontroller 10 compares the received signals with the sample signals, such as comparing whether the received signals are consistent with any of the sample signals in terms of frequency and amplitude. If consistent, the signals collected by the sound wave sensor 11 are determined to be alarm signals emitted by the existing, audio-emitting sensor; otherwise, the signals collected by the sound wave sensor 11 are noise. Additionally or alternatively, the microcontroller 10 can include the sound wave signal processing circuit 12.

Simultaneously or subsequently, the microcontroller 10 also examines the readings from the temperature signal processing circuit 14 and judges whether the temperature represented by the readings from the temperature signal processing circuit 14 is higher than a threshold value (and/or is changing faster than a threshold rate). Preferably, a temperature threshold value (and/or rate) data is pre-stored within the microcontroller 10, and after receiving the signals from the temperature signal processing circuit 14, the microcontroller 10 compares the temperature represented by the received signals with the temperature threshold (and/or rate) value, and judges whether the temperature represented by the received signals is higher than the threshold value (and/or is changing faster than a threshold rate).

In the above described manner, the microcontroller 10 judges whether the condition of generating an alarm is met based on the signals sent by the sound wave signal processing circuit 12 and the temperature signal processing circuit 14. If the condition of generating an alarm is met, then the microcontroller 10 sends the alarm signals through the wireless signal transceiving circuit 16. In this example, the wireless signal transceiving circuit 16 can be a Wireless-Fidelity™ (WIFI) signal transceiving circuit, an infrared signal transceiving circuit, a Bluetooth™ signal transceiving circuit, or a wireless radio frequency (RF) transceiving circuit. The wireless signal transceiving circuit 16 can send and receive wireless signals, and is suitable for remote monitoring applications.

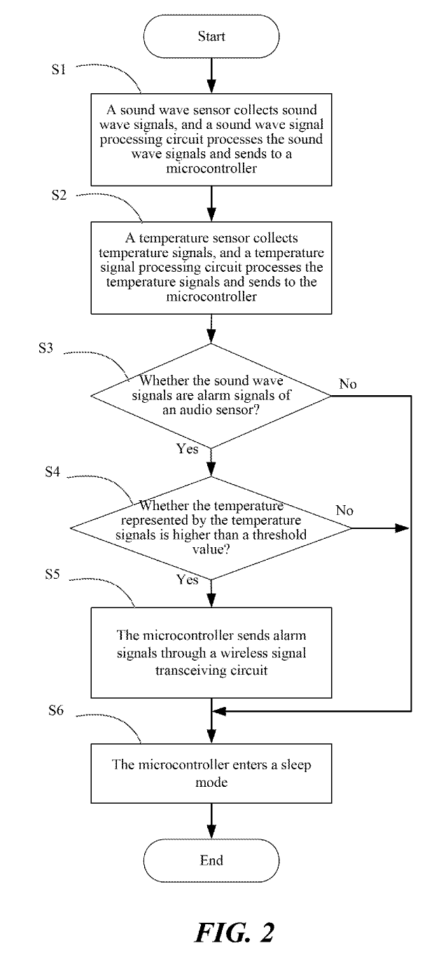

An example working method of the sound wave and temperature sensor is illustrated below with reference to FIG. 2. First, the sound wave and temperature sensor collects the sound wave signals (e.g., emitted by existing smoke and CO sensors) in the ambient environment by the sound wave sensor 11, in Step S1. After the sound wave sensor 11 collects the sound wave signals, the sound wave signal processing circuit 12 processes the sound wave signals collected by the sound wave sensor 11, and sends the processed signal to the microcontroller 10.

Meanwhile, the temperature sensor 13 collects the temperature signals in the ambient environment, and sends the temperature signals to the temperature signal processing circuit 14. The temperature signal processing circuit 14 processes the signals collected by the temperature sensor 13, and sends the processed signals to the microcontroller 10, in Step S2.

After receiving the signals sent by the sound wave signal processing circuit 12 and the temperature signal processing circuit 14, the microcontroller 10 performs Step S3. The microcontroller 10 judges whether the signals output by the sound wave signal processing circuit 12 are the alarm signals sent based on the audio signal (e.g., by comparing the signals output by the sound wave signal processing circuit 12 with the sample signals), and judges whether the received signals are consistent with the sample signals (e.g., in terms of frequency and amplitude). If the received signals are consistent with the sample signals, then Step S4 is executed; otherwise, Step S6 is executed, in which the microcontroller 10 enters a sleep mode to save power consumption.

In Step S4, the microcontroller 10 judges whether the temperature read by the temperature signal processing circuit 14 is higher than a threshold value. For example, the microcontroller 10 compares the temperature represented by the signal output of the temperature signal processing circuit 14 with a threshold value. If the temperature is higher than the threshold value, then the microcontroller 10 indicates that a fire accident may have occurred (i.e., the fire alarm condition is met). Then, the microcontroller 10 executes Step S5, in which the microcontroller 10 sends an alarm to the wireless signal transceiving circuit 16, which in turn sends the alarm to a backend server (e.g., by sending the alarm to a home security device that is communicatively coupled to the backend server). The alarm signals sent by the wireless signal transceiving circuit 16 are in the form of wireless signals, and in some embodiments, having a long transmission distance.

In Step S4, if the microcontroller 10 judges that the temperature represented by the signals output by the temperature signal processing circuit 14 is lower than the threshold value, the microcontroller 10 judges that the alarm condition is not met, then executes Step S6, entering a sleep mode.

After executing Step S5, i.e., sending the alarm signals through the wireless signal transceiving circuit 16, the microcontroller 10 executes Step S6 and enters a sleep mode. Based on the above, after the alarm condition is not met or the alarm signals are sent, the microcontroller 10 enters a sleep mode. Therefore, according to some embodiments, the microcontroller 10 may stay in the sleep mode for an extended period of time, and may only wake up to operate when the alarm signals need to be sent, thus accomplishing extremely low power consumption. In this manner, the microcontroller 10 can achieve prolonged operating lifetime with a relatively small storage battery 15 to power the microcontroller 10.

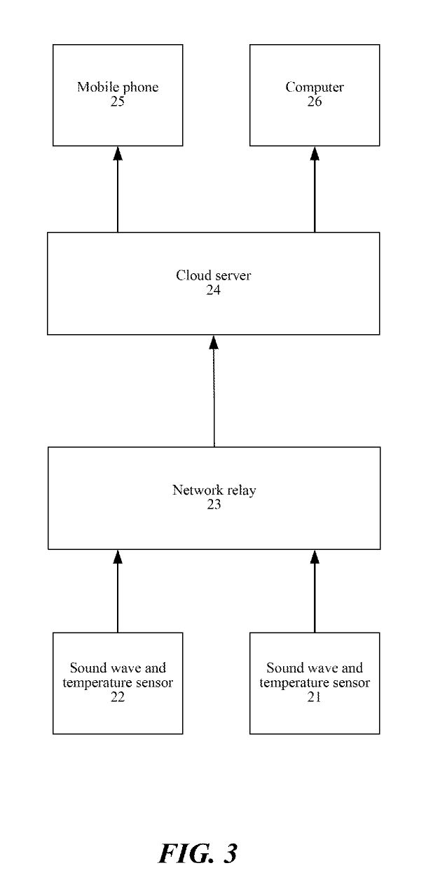

The sound wave and temperature sensor of the present disclosure may be suitable in the field of Internet of things, and can be integrated as a part of a larger, intelligent security system. With reference to FIG. 3, in an intelligent security system, a number of sound wave and temperature sensors 21 and 22 can be installed in a monitoring area. Each of the sound wave and temperature sensors 21 and 22 can be installed near the audio sensor to detect the alarm signals sent by the existing, audible sensors.

The sound wave and temperature sensors 21 and 22 can send alarms in the form of wireless signals. A network relay 23, upon receiving the wireless signals, packages the alarms into data in a network transmission data format, such as TCP/IP or UDP, and transmits via the network transmission to a cloud server 24. Then, the cloud server 24 can send the alarms to terminals such as a mobile phone 25, a personal computer 26, etc., to alert the user that a fire accident may have occurred in the monitoring area. An example application of the network relay 23 is a home security device.

In the manners introduced above, the sound wave and temperature sensor, by collecting sound wave alarm signals emitted by the existing smoke sensor and the CO sensor, in combination with the temperature signals collected itself, judges whether a fire accident has occurred, thereby effectively monitoring the fire alarm. Moreover, the sound wave and temperature sensor need not cling to the existing, audible sensors, and therefore it does not affect the operation of the audible sensor, nor does it risk damaging or destroying the structure of the audible sensor.

In addition, the sound wave and temperature sensor receives and/or sends wireless signals through a wireless signal transceiving circuit 16, which in turn transmits the raised alarm signals via the network transmission to the backend server. This is suitable for remote monitoring applications, and is particularly useful in the Internet of things field.

The above-mentioned examples are merely implementation examples of the present disclosure. Variations can be made to the disclosed embodiments depending on the practical application; for example, the microcontroller can detect the temperature in the ambient environment through the temperature sensor after judging that the alarm signals sent by the audio sensor are received; additionally or alternatively, the sound wave and temperature sensor itself can also send out the sound and light alarm signals. These variations can be made by a person having ordinary skill in the art to achieve the various aspects of the present disclosure.

Note that the present disclosure is not limited to the above implementations. Obvious alternatives such as the change in the type of the audio sensor from which the sound wave and temperature sensor receives signals, and the change in the type of wireless signals sent by the wireless signal transceiving circuit, are included in the scope of the present disclosure.

1. An apparatus comprising:
a sound sensor;
a temperature sensor;
a communication circuit; and
a microcontroller coupled to the sound sensor, the temperature sensor, and the communication circuit, wherein the microcontroller is configured to:
responsive to the sound sensor detecting an audible alarm emitted from an environmental detector that is separate from the apparatus, determine whether an output from the temperature sensor exceeds a threshold value; and
responsive to both the sound sensor detecting the audible alarm and the output from the temperature sensor exceeding a threshold value, cause the communication circuit to transmit an alert to a recipient.

2. The apparatus of claim 1, wherein the microcontroller is further configured to:
detect the audible alarm by comparing a frequency of a detected sound with a number of predetermined sound frequencies.

3. The apparatus of claim 1, wherein the microcontroller is further configured to:
exit a low power mode upon the audible alarm being detected.

4. The apparatus of claim 1, wherein the microcontroller is further configured to:
detect the audible alarm by comparing a frequency of a detected sound with a number of predetermined sound frequencies; and
exit a low power mode upon the audible alarm being detected.

5. The apparatus of claim 1, wherein the microcontroller is further configured to:
enter a low power mode after the alert is transmitted.

6. The apparatus of claim 1, further comprising:
a battery coupled to the apparatus to provide power.

7. The apparatus of claim 1, wherein the recipient is a server.

8. The apparatus of claim 1, wherein the recipient is a home security controller device separate from the apparatus.

9. The apparatus of claim 1, wherein the alert is destined for a mobile device of a user.

10. The apparatus of claim 1, wherein the communication circuit is a wireless network circuit.

11. The apparatus of claim 1, wherein the communication circuit includes at least one of: a WIFI™ communication circuit, a Bluetooth™ communication circuit, or an infrared communication circuit.

12. The apparatus of claim 1, wherein the audible alarm has a frequency that is specific to at least one of: a smoke detector, or a carbon monoxide (CO) detector.

13. A method for detecting a fire using a device and based on an existing environmental detector that is separate from the device, the method comprising:
detecting, via a sound sensor in the device, an audible alarm emitted from the existing environmental detector;
responsive to the sound sensor detecting an audible alarm emitted from the existing environmental detector, determining, via a temperature sensor in the device, whether an output from the temperature sensor exceeds a threshold value; and
responsive to both the sound sensor detecting the audible alarm and the output from the temperature sensor exceeding a threshold value, causing a communication circuit in the device to transmit an alert to a recipient.

14. The method of claim 13, wherein detecting the audible alarm comprises:
comparing a frequency of a sound detected by the sound sensor with a number of predetermined sound frequencies.

15. The method of claim 13, further comprising:
exiting a low power mode upon detecting the audible alarm.

16. The method of claim 13, further comprising:
entering a low power mode after transmitting the alert.

17. The method of claim 13, further comprising:
powering the device by a battery in the device.

18. The method of claim 13, wherein the recipient is at least one of: a server, or a home security controller device separate from the apparatus.

19. The method of claim 13, wherein the alert is destined for a mobile device of a user.

20. The method of claim 13, wherein the communication circuit is a wireless network circuit.
